(19) United States
(12) Patent Application Publication
(10) Pub. No.: US 2016/0024295 A1
(43) Pub. Date: Jan. 28, 2016

(54) AMINIC HARDENERS WITH IMPROVED CHEMICAL RESISTANCE

(71) Applicant: BLUE CUBE IP LLC, Midland,, MI (US)

(72) Inventors: Krishnan Karunakaran, Lake Jackson, TX (US); Rajesh H. Turakhia, Lake Jackson, TX (US); Eric B. Ripplinger, Lake Jackson, TX (US)

(73) Assignee: BLUE CUBE IP LLC, Midland, MI (US)

(21) Appl. No.: 14/773,504

(22) PCT Filed: Mar. 10, 2014
(86) PCT No.: PCT/US14/22600

§ 371 Date: Sep. 8, 2015

Related U.S. Application Data
(60) Provisional application No. 61/823,961, filed on May 16, 2013.

(51) Int. Cl. C08L 63/04

(52) U.S. Cl. CPC C08L 63/04; C08L 2205/24

(57) ABSTRACT

A hardener composition comprising: a) an epoxy-amine adduct of i) a novolac epoxy resin; and ii) a first amine and b) a modifier wherein the hardener has a viscosity in the range of from 50 to 20,000 mPa·s and wherein a cured epoxy thermoset comprising the hardener exhibits no more than 1% weight loss or gain after immersion in concentrated mineral acid for 7 days at a temperature in the range of from 25° C. to 130° C., is disclosed. The hardener composition can be used with an epoxy resin to form a curable composition.

### REFERENCE TO RELATED APPLICATIONS

This application claims benefit of U.S. Provisional Application No. 61/823,961, filed on May 16, 2013.

### BACKGROUND OF THE INVENTION

1. Field of the Invention

The present invention is related to epoxy thermosets that provide improved chemical resistance. Specifically, the present invention is related to aminic hardeners for epoxy thermosets that provide improved chemical resistance.

### Introduction

Epoxy—amine thermosets are suitable for a wide range of applications, such as flooring, mortars, adhesives, coatings, lacquers, and paints. Such epoxy amine systems consist of (a) an epoxy resin and (b) an aminic hardener. The aminic hardener typically consists of (1) an epoxy—amine adduct (2) a modifier such as benzyl alcohol or nonyl phenol. The epoxy-amine adducts are made by reacting epoxy resin with a large excess of amine to get a mixture of amine terminated/capped epoxy resins and free amine. The necessity of including epoxy—amine adducts in the hardener is well documented in the literature, namely, (1) to increase the reactivity of the aminic hardener due to the presence of hydroxyl groups generated by the reaction of the epoxy resin and amine and most importantly (2) to decrease blushing on the cured thermoset by increasing the compatibility of epoxy resin and the aminic hardener during the curing process.

Epoxy—amine thermosets formed by the curing of epoxy resins with aminic hardeners are resistant to standard chemicals like water, very dilute mineral acids (10 weight % hydrochloric acid, 10 weight % sulfuric acid etc). However, such thermosets cannot withstand highly concentrated mineral acids (sulfuric acid, hydrochloric acid, phosphoric acid, nitric acid etc). Mineral acids are widely used in the industry. There is a need to protect flooring, pipes, tanks, and other materials from the corrosive nature of these mineral acids. Therefore, a need remains for an amine hardener which upon curing with epoxy resin provide thermosets resistant to concentrated mineral acids.

### SUMMARY OF THE INVENTION

In one broad embodiment of the present invention, there is disclosed a hardener composition comprising, consisting of, or consisting essentially of: a) an epoxy-amine adduct of i) a novolac epoxy resin and ii) a first amine; and b) a modifier wherein the hardener has a viscosity in the range of from 50 to 20,000 mPa·s and wherein a cured epoxy thermoset comprising the hardener exhibits no more than 1% weight loss or gain after immersion in concentrated mineral acid for 7 days at a temperature in the range of from 25° C. to 130° C.

### DETAILED DESCRIPTION OF THE INVENTION

### Adduct of Novolac Epoxy Resin and Amine

In an embodiment, one component of the composition is an epoxy-amine adduct of a novolac epoxy resin i) and a first amine ii).

Examples of epoxy novolac resins include, but are not limited to D.E.N.™ 425, D.E.N.™ 431, D.E.N.™ 438 from Dow Chemical Company. Formula 1 depicts the general structure of novolac resins. The structures of bisphenol F and novolac resin vary only on the ‘n’ value. When n=0 to −0.3, it is generally referred to as a bisphenol F resin.

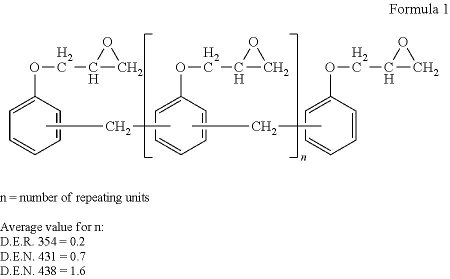

Examples of bisphenol F epoxy resins include but are not limited to diglycidyl ether of bisphenol F namely D.E.R.™ 354 from Dow Chemical Company and EPON Resin 862 from Momentive.

Examples of the first amine ii) include but are not limited to aliphatic polyamines, arylaliphatic polyamines, cycloaliphatic polyamines, aromatic polyamines, heterocyclic polyamines, polyalkoxypolyamines, phenalkamines and combinations thereof. The alkoxy group of the polyalkoxypolyamines is an oxyethylene, oxypropylene, oxy-1,2-butylene, oxy-1,4-butylene or a co-polymer thereof.

Examples of aliphatic polyamines include, but are not limited to ethylenediamine (EDA), diethylenetriamine (DETA), triethylenetetramine (TETA), tetraethylenepentamine (TEPA), trimethyl hexane diamine (TMDA), hexamethylenediamine (HMDA), N-(2-aminoethyl)-1,3-propanediamine (N3-Amine), N,N′-1,2-ethanediylbis-1,3-propanediamine (N4-amine), and dipropylenetriamine. Examples of arylaliphatic polyamines include, but are not limited to m-xylenediamine (mXDA), and p-xylenediamine. Examples of cycloaliphatic polyamines include, but are not limited to 1,3-bisaminomethyl cyclohexane (1,3-BAC), isophorone diamine (IPDA), 4,4′-methylenebiscyclohexanamine, bis-(p-aminocyclohexyl) methane and 1,2-diamino cyclohexane (1,2-DACH). Examples of aromatic polyamines include, but are not limited to m-phenylenediamine, diaminodiphenylmethane (DDM), and diaminodiphenylsulfone (DDS).

The epoxy-amine adducts are made by reacting the epoxy resin with excess of amine. In one embodiment the epoxy-amine adduct is made by reacting 5 to 75 weight % of epoxy resin with an amine. In another embodiment the epoxy-amine adduct is made by reacting 10 to 70 weight % of epoxy resin with amine. In another embodiment, the epoxy-amine adduct is made by reacting 30 to 65 weight % epoxy resin with amine. In another embodiment the epoxy-amine adduct is made by reacting 40 to 60 weight % epoxy resin with amine.

The epoxy-amine adduct could also be made in presence of modifier detailed elsewhere in the patent application.

Generally, one of ordinary skill in the art can determine the amount of the epoxy-amine adduct to use in the hardener formulation. The nature of the first amine component used and the degree of the reaction with the novolac epoxy component can strongly affect the viscosity of the epoxy-amine adduct.

In an embodiment, the epoxy-amine adduct is present in the hardener composition in the range of from 5 weight percent to 80 weight percent, based on the total weight of the composition. The epoxy-amine adduct is present in the hardener composition in the range of from 6 weight percent to 50 weight percent in another embodiment, and from 7 weight percent to 45 weight percent in yet another embodiment.

### Modifier

The composition also includes a modifier. The modifier is useful for dilution and may accelerate the curing speed in combination with epoxy resins. The modifier can also enhance surface appearance.

Examples of modifiers include, but are not limited to styrenated phenol, diisopropylnaphthalene, polyalkylene glycols, ethers of polyalkylene glycols, benzyl alcohol, and high boiling mono- or polyhydric alcohols, nonyl phenol, ethers of phenolic polyalkylene glycols or mixtures thereof.

The modifier is generally present in a range of from 5 weight percent to 50 weight percent, based on the total weight of the composition.

### Optional Components

### Accelerator

The hardener composition can also include an accelerator, which accelerates the curing speed of the composition with an epoxy resin.

Examples of accelerators include, but are not limited to salicylic acid, calcium nitrate, bisphenol A, bisphenol F, resorcinol, tris(2,4,6-dimethylamino methyl)phenol, hydroquinone or other carboxylic and/or phenolic group containing component.

The accelerator is generally present in the hardener composition in the range of from 0.5 weight percent to 15 weight percent, based on the total weight of the composition.

### Second Amine

In an embodiment, the composition can contain a second amine. The second amine can be any of the amines listed above. In an embodiment, the second amine can be either aliphatic polyamines, cycloaliphatic polyamine like IPDA, PACM, 1,2-DACH or phenalkamines or mixtures thereof.

The second amine is generally present in an amount in the range of 5 weight percent to 70 weight percent, based on the total weight of the hardener composition. In an embodiment, the second amine can be present in a range of from 7 weight percent to 60 weight percent, based on the total weight of the hardener composition, and from 8 weight percent to 50 weight percent, based on the total weight of the hardener composition in yet another embodiment.

In an embodiment, the hardener composition has a viscosity in the range of from 50 to 20,000 mPa·s.

### Process for Producing the Hardener Composition

In an embodiment, the formation of component a), epoxy-amine adduct, takes place at elevated temperatures from 30 to 120° C. under reaction control by speed of addition. The addition speed depends mainly on the cooling power of the reactor used. In an embodiment, the temperature is in the range of from 50° C. to 85° C. The reactor is charged with the first amine and the epoxy is added from top under stirring. After addition is finished, a post reaction of 10 minutes to 6 hours is performed. During the post reaction time the reaction between the epoxy resin and amine continues to completion, so that no unreacted epoxy remains in the reaction mixture.

In another embodiment, the epoxy-amine adduct could be made in presence of the modifier. The modifier keeps the viscosity of the epoxy-amine adducts low to facilitate efficient mixing.

Once the epoxy-amine adduct is formed, the other components can be added in any combination or sub-combination.

### Curable Thermoset Composition

In an embodiment, a curable thermoset composition comprises, consists of, or consists essentially of: I) the above-described hardener and II) an epoxy resin.

In an embodiment, the epoxy resin is a liquid epoxy resin. Examples of liquid epoxy resins that can be used include, but are not limited to bisphenol-A diglycidyl ethers (BADGE), epoxy novolac resins including diglycidyl ether of bisphenol F. Examples of bisphenol A diglycidyl ethers include, but are not limited to D.E.R. 331 and D.E.R. 383 from Dow Chemical Company. Examples of epoxy novalac resins include, but are not limited to D.E.R.™ 354, D.E.N.™ 425, D.E.N.™ 431, D.E.N.™ 438 from Dow Chemical Company.

The curable composition can be optionally diluted with reactive diluents such as for example cresyl glycidyl ether (CGE), p. t.-butylphenyl glycidyl ether (ptBPGE), C12/C14 glycidyl ether, butanediol diglycidyl ether (BDDGE), hexanediol-diglycidyl ether (HDDGE), branched glycidyl ethers such as C13/15 alcohol glycidyl ether, and glycidyl esters such as Versatic Acid glycidyl esters.

In an embodiment, the hardener component and the epoxy resin are mixed according to the hardener equivalent weight (HEW) and epoxide equivalent weight (EEW) to ensure that from 0.8 to 1.3 equivalents of epoxy mixed with 1 equivalent amine hydrogen.

In an embodiment, the hardener component and the epoxy resin are mixed according to the hardener equivalent weight (HEW) and epoxide equivalent weight (EEW) to ensure that 0.9 -1.2 equivalent of epoxy mixed with 1 equivalent amine hydrogen.

In an embodiment, the hardener component and the epoxy resin are mixed according to the hardener equivalent weight (HEW) and epoxide equivalent weight (EEW) to ensure that 1.0 -1.1 equivalent of epoxy mixed with 1 equivalent amine hydrogen.

The curing thermoset composition may optionally contain other ingredients namely toughening agents, flexibilizers and fillers. In an embodiment, a toughening agent such as core shell rubbers, amphiphilic block copolymers, acrylonitrile-butadiene rubbers and polyols can be present in an amount in the range of from 3 weight percent to 10 weight percent in the curing thermoset composition.

The thermoset composition can be cured at various temperatures. In an embodiment, the curing temperature is in the range of from 0° C. to 140° C. In an embodiment, the curing temperature is in the range of from 5° C. and 100° C. and in another embodiment the curing temperature is in the range of from 10° C. and 90° C.

In an embodiment, a cured product comprising the above curable composition exhibits no more than 1% weight loss or gain after immersion in concentrated mineral acid for 7 days. A mineral acid is an inorganic acid. A concentrated mineral acid has the standard purity supplied by manufacturers. The purity percentage varies depending upon the particular acid. Examples of concentrated mineral acids include, but are not limited to 50 to 98 weight percent sulfuric acid, 20 to 38 weight percent hydrochloric acid, 30 to 99 weight percentage phosphoric acid, and 50 to 99 percent nitric acid.

In an embodiment, the concentrated mineral acid is 50 to 98 weight percent sulfuric acid. In another embodiment the concentrated mineral acid is 20 to 38 percent hydrochloric acid. In another embodiment the concentrated mineral acid is nitric acid.

In an embodiment the chemical resistance to concentrated mineral acid is at a temperature range of 20° C. to 130° C. In another embodiment the chemical resistance is at temperature range of 25 to 100° C. In another embodiment the chemical resistance is at temperature range of 30 to 90° C.

Such aminic hardeners could be used in a broad range of civil engineering applications like trowellable and self-leveling flooring, crack bridging, protective coating for concrete and metal substrates etc where resistance to mineral acids are critical.

### EXAMPLES

In the following examples, various terms and designations used such as for example:
D.E.R. 354: Diglycidyl ether of bisphenol F from Dow Chemical.
D.E.H. 24: Triethylene tetramine (TETA) from Dow Chemical.
IPDA: Isophorone diamine from Evonik.
1,2-DACH: 1,2-diamino cyclohexane from Invista.
98% sulfuric acid from Aldrich Chemicals
38% concentrated hydrochloric acid from Aldrich Chemical.

Hardener 1

70 grams of TETA was heated to 60° C. Under stirring, 30 grams of diglycidyl ether of bisphenol F was added. After one hour, 100 grams of a high viscous clear liquid was yielded. 60 grams of this bisphenol F—amine adduct was mixed with 40 grams of benzyl alcohol to produce Hardener 1.

Hardener 2

30 grams of TETA and 50 grams of benzyl alcohol were heated to 60° C. Under stirring, 20 grams of diglycidyl ether of bisphenol F was added. After ensuring the complete reaction of diglycidyl ether of bisphenol F (˜5 hours), the mixture was then cooled to produce Hardener 2 which had a viscosity of 14000 mPa·s.

Hardener 3

17 grams of TETA and 33 grams of benzyl alcohol were heated to 60° C. Under stirring, 25.5 grams of diglycidyl ether of bisphenol F was added. After ensuring the complete reaction of diglycidyl ether of bisphenol F (˜5 hours), 25 grams of IPDA was added and stirred well to produce about 100 grams of Hardener 3 which had a viscosity 9500 mPa·s.

Hardener 4

17 grams of TETA and 33 grams of benzyl alcohol were heated to 60° C. Under stirring, 25.5 grams of diglycidyl ether of bisphenol F was added. After ensuring the complete reaction of diglycidyl ether of bisphenol F (˜5 hours), 25 grams of 1,2-DACH was added and the mixture was then thoroughly stirred to produce about 100 grams of Hardener 4 having a viscosity of 1750 mPa·s.

Hardener 5 17 grams of TETA and 33 grams of benzyl alcohol were heated to 60° C.

Under stirring, 25.5 grams of diglycidyl ether of bisphenol F was added. After ensuring the complete reaction of diglycidyl ether of bisphenol F (˜5 hours), 25 grams of phenalkamine (NC 541 LV from Cardolite Corporation) was added and the mixture was then thoroughly stirred to produce about 100 grams of hardener 5 having a viscosity of 11000 mPa·s.

Hardener A (Comparative Example)

70 grams of TETA were heated to 60° C. Under stirring, 30 grams of diglycidyl ether of bisphenol A was added. After one hour, 100 grams of a high viscous clear liquid was yielded. 60 grams of this bisphenol A—amine adduct was mixed with 40 g of benzyl alcohol to produce Hardener A.

Hardener B (Comparative example)

30 grams of TETA and 50 grams of benzyl alcohol were heated to 60° C. Under stirring, 20 grams of diglycidyl ether of bisphenol A was added. After ensuring the complete reaction of diglycidyl ether of bisphenol A (˜5 hours), the mixture was then cooled to produce Hardener B having a viscosity of 16000 mPa·s.

### Curable Compositions

The curable thermoset compositions were made by mixing an epoxy resin and the hardeners at room temperature according to the formulations in Table 1, below.

TABLE 1
Recipes of the curable compositions

| | | Hardener | D.E.R. 354 epoxy |
|---|---|---|---|
| Example | Hardener Type | (grams) | resin (grams) |
| Inventive Example 1 | Hardener 1 | 25.7 | 74.4 |
| Inventive Example 2 | Hardener 2 | 42.5 | 57.5 |
| Inventive Example 3 | Hardener 3 | 34 | 66 |
| Inventive Example 4 | Hardener 4 | 29 | 71 |
| Comparative Example A | Hardener 5 | 48 | 100 |
| Comparative Example B | Hardener 6 | 42 | 100 |

After homogenization of both components for 2 minutes, the liquid mixture was poured into aluminum pans, resulting in a thickness of 4 mm and was then cured for 7 days at room temperature or 2 days at room temperature followed by 1 day at 50° C.

Chemical Resistance Evaluation

The thermoset was weighed and the initial weight (˜12 grams) was noted. It was then placed in 98% sulfuric acid for 7 days at either ambient temperature or 60° C. The sample was removed from the sulfuric acid, rinsed with distilled water, water removed by wiping with paper and the sample weight was noted. The sample was put back in sulfuric acid and next measurement was done after 28 days. The weight loss/gain decrease over a predetermined period of time is a good indication for the resistance against the different test liquids.

Results

The results are shown in Tables 2 and 3.

TABLE 2
Chemical resistance study at 60° C. in 98% sulfuric acid (after curing the
sample at 2 days at ambient temp + 1 day at 50° C.)

| | Wt gain/loss after 7 | Additional wt gain/ |
|---|---|---|
| Example | days | loss after 28 days |
| Inventive Example 1 | 0.2% wt loss | No further wt loss |
| Inventive Example 2 | 0.1% wt loss | No further wt loss |
| Inventive Example 3 | 0.3% wt gain | 0.2% wt loss |
| Inventive Example 4 | 0.35% wt gain | 0.1% wt loss |
| Comparative Example A | 1% wt loss | 3% wt loss |
| Comparative Example B | 10% wt loss | disintegrated |

TABLE 3
Chemical resistance study at 60° C. in 98% sulfuric acid (after curing at
ambient temperature for 7 days)

| | Wt gain/loss after 7 | Wt gain/loss after 28 |
|---|---|---|
| Example | days | days |
| Inventive Example 1 | 0.5% wt loss | No further wt loss |
| Inventive Example 2 | 0.2% wt loss | No further wt loss |
| Inventive Example 3 | 0.6% wt gain | 0.1% wt gain |
| Inventive Example 4 | Not done | Not done |
| Comparative Example A | 3% wt loss | 8% wt loss |
| Comparative Example B | disintegrated | — |

As is evident from the above Tables, the cured inventive product exhibits an improved chemical resistance against sulfuric acid relative to comparative examples A and B.

1. A hardener composition comprising:
a) an epoxy-amine adduct of
i) a novolac epoxy resin; and
ii) a first amine and
b) a modifier;
wherein the hardener has a viscosity in the range of from 50 to 20,000 mPa·s, and wherein a cured epoxy thermoset comprising the hardener exhibits no more than 1% weight loss or gain after immersion in concentrated mineral acid for up to 28 days at a temperature of 25° C. to 130° C.

2. A hardener composition in accordance with claim 1 wherein said novolac epoxy resin is a bisphenol F epoxy resin.

3. A hardener composition in accordance with claim 1 wherein the epoxy-amine adduct is made by reacting from 30 to 65 weight percent of epoxy resin with amine.

4. A hardener composition in accordance with claim 1 wherein said amine is an aliphatic polyamine selected from the group consisting of ethylene diamine, diethylene triamine, triethylene tetramine, tetraethylene pentamine, N-(2-aminoethyl)-1,3-propanediamine(N3-Amine), N,N′-1,2-ethanediylbis-1,3-propanediamine (N4-amine), and dipropylenetriamine.

5. A hardener composition in accordance with claim 1 wherein said amine is an cycloaliphatic polyamine selected from the group consisting of isophorone diamine, 1,3-bisaminomethyl cyclohexane, bis-(p-aminocyclohexyl) methane, and 1,2-diaminocyclohexane.

6. A hardener composition in accordance with claim 1 further comprising c) a second amine.

7. A hardener composition in accordance with claim 6 wherein said second amine is selected from the group consisting of cycloaliphatic polyamines, aliphatic polyamines and mixtures thereof.

8. A hardener composition in accordance with claim 6 wherein said second amine is a phenalkamine.

9. A hardener composition in accordance with claim 1 wherein said modifier is selected from the group consisting of styrenated phenol, diisopropylnaphthalene, benzyl alcohol, and nonyl phenol.

10. A hardener composition in accordance with claim 1 further comprising c) an accelerator.

11. A hardener composition in accordance with claim 10 wherein said accelerator is selected from the group consisting of salicylic acid , calcium nitrate, tris (2,4,6-dimethylamino methyl)phenol and phenolic group-containing compounds.

12. A hardener composition in accordance with claim 1 wherein the epoxy-amine adduct is present in an amount in the range of from 10 weight percent to 80 weight percent, and the modifier is present in an amount in the range of from 5 weight percent to 50 weight percent, based on the total weight of the composition.

13. A hardener composition in accordance with claim 6 wherein the second amine is present in an amount in the range of from 10 weight percent to 80 weight percent, based on the total weight of the composition.

14. A hardener composition in accordance with claim 10 wherein the accelerator is present in an amount in the range of from 0.5 weight percent to 15 weight percent, based on the total weight of the composition.

15. A process comprising:
a) contacting a novolac epoxy resin and a first amine under reaction conditions to form an epoxy-amine adduct; and
b) admixing
i) said epoxy-amine adduct ; and
ii) a modifier to form a hardener composition.

16. A process in accordance with claim 15 wherein said novolac epoxy resin is a bisphenol F epoxy resin.

17. A process in accordance with claim 15 wherein said reaction conditions in step a) comprise a reaction temperature in the range of from 60° C. to 120° C.

18. A curable epoxy thermoset composition comprising:
I) the hardener composition of claim 1; and
II) an epoxy resin selected from the group consisting of liquid bisphenol-A diglycidyl ethers, liquid bisphenol-F diglycidyl ethers, liquid epoxy novolacs, and
combinations thereof.

19. A curable thermoset composition of claim 18, wherein said composition exhibits no more than 1% weight loss or gain after immersion in concentrated mineral acid for up to 28 days at a temperature of 25° C. to 130° C.

20. A curable thermoset composition of claim 18, wherein said composition exhibits no more than 1% weight loss or gain after immersion into concentrated mineral acid for up to 7 days at a temperature up to 60° C.
